(19) United States
(12) Patent Application Publication
(10) Pub. No.: US 2011/0198525 A1
(43) Pub. Date: Aug. 18, 2011

(54) FLOATING CONICAL PLUG VALVE

(76) Inventor: Shijun Yu, Shanghai (CN)

(21) Appl. No.: 12/671,608

(22) PCT Filed: Nov. 12, 2007
(86) PCT No.: PCT/CN07/03191

§ 371 Date: Feb. 1, 2010

(30) Foreign Application Priority Data
Sep. 18, 2007 (CN) 200710046094.6

(51) Int. Cl. F16K 5/04

(52) U.S. Cl. 251/309

(57) ABSTRACT

This invention relates to a floating conical plug valve comprising the valve body with a path for medium passing by, the conical valve chamber which is intersected into the said path perpendicularly, a conical valve core which can be turned, inserted in valve chamber, used for cutting off the said path in case of valve closed, a valve stem for turning of the valve core and a spring fitted between the bottom of the valve core and the valve chamber, the valve cap is on the top of the valve body which characterized in that the said valve core features a floating conical plug valve core which can be moved up and down within the valve chamber, there is a rotational transmission sleeve on the top of the valve core, with the torque limited sliding block and the torsion transmission pin outside of the valve stem, the rotational telescopic inner sleeve matched up and by screw thread is fitted between the rotational transmission sleeve and the valve stem, there is the telescopic outer sleeve outside of the telescopic inner sleeve, In this invention it only needs one handle turning in one direction that the valve core can firstly be lifted and turned by a certain angle and then pressed downwardly for sealing engagement; there are no seal film between the surfaces of conical valve chamber and valve core, no losses caused by friction and erosion, small worn out and simplification in structure.

### TECHNICAL FIELD

This invention relates to a floating conical plug valve, particularly, to a floating plug valve which makes the deflection of stream or changes the status of opening up and breaking off for a liquid, is applicable as a manual or electric-driven, one-way, three-way and four-way valve in cases of high fluctuation of temperature, high pressure and strict requirement of seal, belonging to valve technology domain.

### TECHNICAL BACKGROUND

Due to the simplification in structure and quickly to open and close as well as reduced pressure drop, the cock valves widely applicable in some industrial fields.

The cock valves sold recently are with the following features: a seal and lubricated film should be set up between the outer surface of the cone and the inner surface of valve chamber, at the larger end of valve core a specific pressure for axial seal should be built up and this specific pressure should be retained unchangeable during the conical valve core is turning, thus the erosion of sealed surfaces is severe because of a quite larger torque during turning. When the seal film is destroyed under the action by high temperature and vibration and then the plug valve couldn't be opened or closed because turning valve core being stagnant on the valve chamber. During application if the temperature and pressure of the liquid suddenly increase and the turning conical valve core may be lost touch with the conical valve chamber on one occasion, then the medium in pipe could flow into sealed chamber, it may be possible to sweep the seal film out. There are some cock valves applied in industrial fields, which lift the valve core at first then press it down after turning, such like lift-type plug valve and dual action cock valve. All of them require two or more actuators or two or more actions, making a rather complicate valve structure and inconvenience in operation caused by, thus the utilization of those improved cock valves may be restricted.

### INVENTION CONTENT

This invention is aimed at to provide a floating conical plug valve with low erosion, perfect sealing engagement and simplified structure. To fulfill above-mentioned target, the technical conception of this invention is to provide

1. A floating conical plug valve comprises the valve body with one inlet port and one outlet port on both sides thereof, and a path connected both ports for medium passing by as well as the conical valve chamber which is intersected into the said path perpendicularly, a conical valve core which can be turned, inserted in conical valve chamber used for cutting off the said path in case of valve closed. The valve also comprises a rotational transmission sleeve and a valve stem actuating the valve core, the rotational transmission sleeve is outside of the valve stem, The floating up spring is clamped between the lower part of valve core and the bottom of valve body. The valve cap with locating pin is fitted on the upper end of the valve body which is characterized in that the valve core is a floating conical valve core which can be moved up and down within the valve chamber. At least one piece of torsion transmission pin with a lower conical section is fitted on the lower end of rotary actuating sleeve, and the equivalent quantity of torque limited sliding block with a upper conical section is fitted on the upper end of the valve core and the sliding spring is clamped between valve core and the torque limited sliding block. On the lower part of the sliding block is the clamp which is anchored on valve core by a bolt, a locknut for sealing the valve stem by pressing tightly on the seal ring is fitted on the upper end of the valve cap. A spring gasket is fitted through bearing “a” between the valve cap and the rotational transmission sleeve. A telescopic inner sleeve which can not only be turned simultaneously with rotational transmission sleeve and the valve stem, but also can be telescopic upward and downward against the valve stem, is fitted between the rotational transmission sleeve and the valve stem though the bearing “b”. Outside of the telescopic inner sleeve there is the telescopic outer sleeve by matching each other screws.

The handle turning in one direction of this invention can realize some functions in series, such as to lift the conical valve core losing touch with the valve body, then continuous turning until to be limited in position after that still to be pressed tightly and added by a specific pressure for sealing engagement, Due to during turning the valve core and valve body are separated completely, the conical valve core is affected under slight erosion when being moved up and pressed down and the friction is also very small because there is no friction between sealed surfaces under fliction. Thus a prompt switching deflection of fluid will be done under a very small torque. In case of high temperature owing to the different expansion rates of conical valve core and valve body, or when the sealed surfaces of conical valve core and valve body are worn out, the axial force has through spring gasket acted on the valve core, thus the leakage wherefrom can be automatically compensated.

In this invention it only needs once handle turning in one direction that the conical valve core can firstly be lifted and turned by a certain angle then pressed downward for sealing engagement. There is no seal film between the surfaces of conical valve chamber and valve core, no losses caused by friction and erosion, The said valve is applicable as a manual or electric-driven, one-way, three-way and four-way valve in cases of high fluctuation of temperature, high pressure and strict requirement of sealing

When a pressure P acted at the top of conical valve core, the seal pressure is equal to P/sin α (α is the half angel of the cone), and when α=6° the seal pressure is 9.6 times larger than the acting pressure. Therefore the seal pressure acted axially by the rotational conical plug valve has been magnified to posses a reliable sealing engagement.

The structure of floating conical plug valve in this invention is characterized in that the rotational conical valve core is in statue of floating during opening and closing thereof, it's mean that handle of valve turning in one direction, though the expanding, contracting and actuating mechanism, then the following switching function are possible:
1. The specific pressure for sealing acted at the top of conical valve core is withdrawn;
2. The conical valve core floated by action of the spring fitted underneath thereof and has lost touch with valve body completely;
3. The rotational transmission sleeve makes the valve core rotating a certain angle and limited in position through the pin and the sliding block which transfers the torque.
4. The valve core is moved down and pressed tightly then brought to bear a certain specific pressure.

The advantage of this invention is that it is only needed one handle turning in one direction that the conical valve core can firstly be lifted and turned by a certain angle then pressed downward for sealing engagement. There are no seal film between the surface of conical valve chamber and valve core face, no rotational friction, small erosion loss, perfect sealing engagement and simplified structure.

### DESCRIPTION OF DRAWING ATTACHED

FIG. 1 is a sketch showing the structure of a floating conical plug valve

FIG. 2 is sketch showing the valve core structure of a floating conical plug valve and the limited position

FIG. 3 is a sketch showing the torque limitation mechanism of a floating conical plug valve and its assembly;

FIG. 4 is a sketch showing telescopic mechanism for valve core moved up during opening of the floating conical plug valve and its assembly;

FIG. 5 is a sketch showing the position of the torque limitation mechanism shown by FIG. 4

FIG. 6 is a sketch showing the torsion limitation mechanism losing touch and setting the specific pressure after a 90° turning of the valve core

FIG. 7 is a sketch showing the position of the torque limitation mechanism under the situation shown by FIG. 6

FIG. 8 is a sketch showing a floating conical plug valve with spring clamp and steel ball

FIG. 9 is a sketch showing transverse cross, as a sectional view of a four-way floating conical plug valve for implementation of the example 3

FIG. 10 is a sketch showing an initiative magnet and a passive magnet used for substitution of the torque limitation mechanism for implementation of the example 4

FIG. 11 is a sketch showing the matching up of the rotational transmission sleeve and the initiative magnet for implementation of the example 4

FIG. 12 is a sketch showing a magnet actuating floating conical plug valve for implementation of the example 5

FIG. 13 is a sketch showing structure of telescopic outer sleeve and telescopic pad

FIG. 14 is a sketch showing structure of the magnet actuating initiative sleeve

A preferred embodiment of the invention is illustrated in the accompanying drawing in which:

### DETAILED DESCRIPTION OF THE PREFERRED EMBODIMENTS

### Implementation of the Example 1

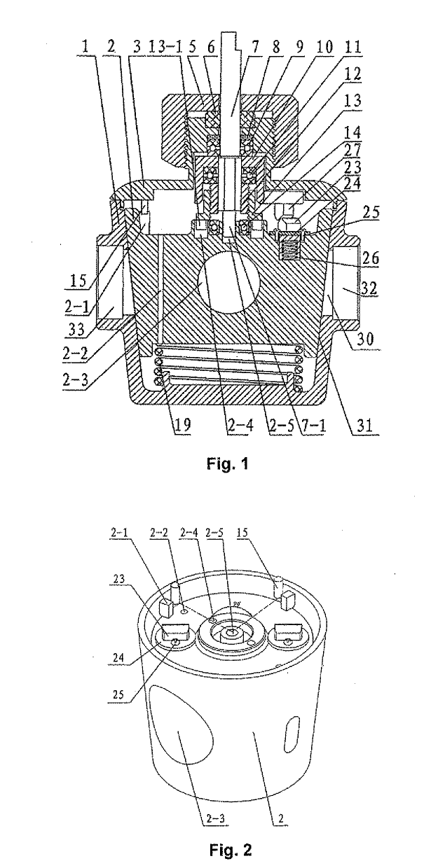

As shown in FIG. 1, wherein a sketch showing a floating conical plug valve in closed position, this floating conical plug valve comprises valve body 1, which has a inlet port 32 and a outlet port 33, and a perforated path 30 for medium passing by, and a conical chamber intersected with the said path 31, a conical valve core 2 which can be turned, is inserted in conical valve chamber used for cutting off the said path 30 in case of valve closed, the said valve core 2 is a telescopic float conical valve core moved up and down against the conical valve chamber 31. The conical plug valve comprises also a rotational transmission sleeve 10 and a valve stem 7, the rotational transmission sleeve 10 is outside of the stem 7, The float upward spring 19 is clamped between the lower part of valve core 2 and the bottom of valve body 1, inside of the valve cap there is a locating pin 15, on the valve cap 3 the locknut 5 is fitted which presses seal ring 6 downwardly to hold the sealing engagement of valve stem 7.

The said rotational transmission sleeve 10 assembled with valve stem 7 form an integrated piece and one, two or more torsion transmission pins 27 are fitted on the lower end thereof (in this example there are two pins), and the torque limited sliding block 23 which quantity is equal to the pin 27, the torque limited pin 27 turns together with the turning rotational transmission sleeve 10 and valve stem 7, after turning a certain angle then touches the torque limited sliding block 23 with a upper conical section. The sliding spring 26 is clamped between valve core 2 and the torque limited sliding block 23. On the upper part of the torque limited sliding block 23 there is a clamp 24, and the clamp 24 is anchored on valve core 2 by bolts 25. A lower conical section is on the lower part of the said torsion transmission pin 27 which taper is matched up the taper in the top of torque limited sliding block 23.

As shown in FIG. 2 wherein a sketch showing the structure of a floating conical valve core 2 and the limitation position, a transversely perforated path 2-3 is on the valve core 2, on the upper part there are two spacers 2-1, the closed angel between two spacers is larger that 90°, the locating pins 15 underneath the valve cap are fitted between two spacers, Either the valve being opened or being closed one of the locating pins 15 will touch one of the spacers, thus the rotation of valve core is limited within 90°.

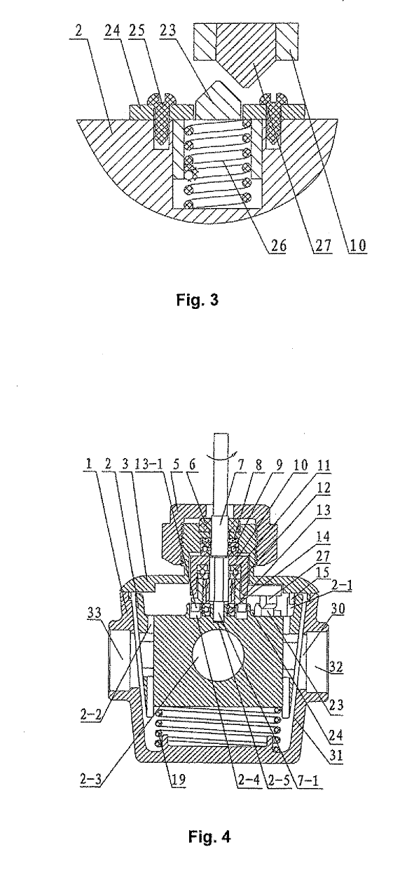

As shown in FIG. 3 wherein a sketch showing the torsion limited mechanism of a floating conical plug valve and its assembly, the said torsion transmission pin 27, torque limited sliding block 23, sliding spring 26, clamp 24 and bolt 25 form the torsion limited mechanism, which function is that when valve core 2 floated up and lost touch with conical valve chamber 31, the turning of valve stem has transferred to the valve core 2 and then the valve core 2 has turned a certain angel and then the spacing is disconnected, in this example the degree of turning is 90°.

The said torsion limited mechanism carries out a turning a certain angel and disconnection of the spacing. Besides where the engaging bevels are the transmission pin 27 and the torque limited sliding block 23 in this example, alternatively two curved surfaces thereof are also adopted, any variation of positions and the structure shapes of the torsion limited mechanism do not change it function and character, thus it is still belonging to the scope of this invention.

A spring gasket 8 is fitted through the bearing “a” between the valve cap 3 and the rotational transmission sleeve 10.

The function of the said spring gasket 8 is to set a specific pressure on the upper part of the valve core 2, to hold the seal pressure of valve core 2 against conical valve chamber 31. Besides, the spring gasket 8 can also be fitted in other appropriate positions other than in this example, for instance, to be fitted between the bearing “a” and the rotational transmission sleeve 10, or between the rotational transmission sleeve 10 and the bearing “b”, any variation of positions and structure shapes of the spring gasket 8 don't change it function.

A telescopic inner sleeve 12 which can not only be turned simultaneously with rotational transmission sleeve 10 and valve stem 7, but can also be telescopic upward and downward against the valve stem 7, outside of the telescopic inner sleeve 12 is the telescopic outer sleeve 13 matched up by screw thread. The lower part of the telescopic inner sleeve 12 or the telescopic outer sleeve 13 is clamped through the bearing “c” on the valve core 2. The anti-rotation pin 13-1, which protects the relative rotation between the telescopic outer sleeve 13 and the valve core 2, is fitted on the lower end of the said telescopic outer sleeve 13, and on the valve core 2, there is a pin socket 2-4 in order to match up the anti-rotation pin 13-1, thus no relative movement can exist between the telescopic outer sleeve 13 and the valve core 2.

The matched pair of the said telescopic inner sleeve 12 and the telescopic outer sleeve 13 form the telescope mechanism is completed by single or multiple screw threads, the pitch of thread is 0.5-1.0 mm.

Some holes for balance 2-2 has longitudinally been perforated from up to bottom of the valve core to hold a balanced pressure of the valve core 2 when it is floated up and pressed down, in so far as the remaining pressure of fluid won't influent the pressure causing floating up and pressing down. The cone of the valve core 2 has a half closed angle of 2-30 degree.

There is an aligned hole 2-5 in top area of the valve core 2, an aligned pin 7-1 is fitted in the low part of the valve stem, which is inserted into aligned hole 2-5 forming a dynamic matched pair, to hold a coaxial position of the valve core 2 and the conical valve chamber 31 and also hold a even gap between the conical seal faces of the valve core 2 and the conical valve chamber 31 when the valve core 2 floated up and lost touch with conical valve chamber 31, during the period of the plug valve opening and closing.

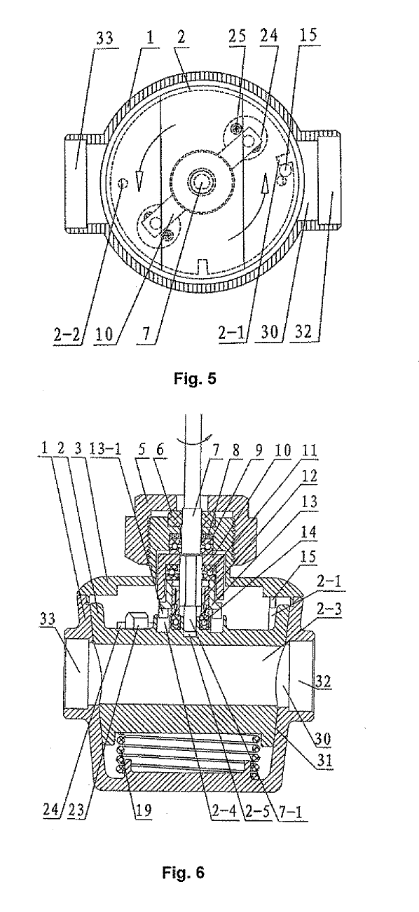

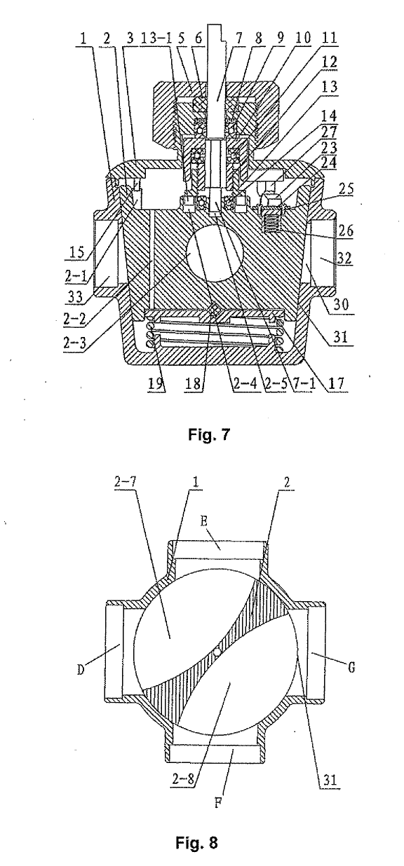

During operation, as shown in FIG. 1, if the plug valve is in closed position induced by turning of valve stem 7 in clockwise direction then the telescopic inner sleeve 12 is upward and the telescopic outer sleeve is downward, if it is desirable to open the valve then to turn the valve in counter-clockwise direction, however the rotational transmission sleeve 10, the torsion transmission pin 27 and the valve stem 7 are combined together thus all of them turn in counter-clockwise direction, and the telescopic inner sleeve 12 turns in synchronized with the valve stem 7, but the telescopic outer sleeve 13 can't turn following the valve core 2, thus the telescopic inner sleeve 12 turns in counter-clockwise direction against the telescopic outer sleeve 13, resulting in telescopic outer sleeve 13 moved up and the telescopic inner sleeve 12 moved down, the axial distance between them becomes smaller (like shrinkage), it comes out that the valve core 2 is floated up under the action of the sliding spring 19, until the top ends of the telescopic inner & outer sleeves will be in the same level, in this moment the valve core 2 loses touch with the conical valve chamber 31 completely; as shown in FIG. 4 the conical bevel of torsion transmission pin 27 in the lower part of the rotational transmission sleeve is exactly meshed with the conical bevel of the torque limited sliding block 23 in the upper part of valve core 2; as shown in FIG. 5 the valve stem 7 turns in counter-clockwise direction and will bring the valve core 2 turning together until the space 2-1 touches the locating pin 15 in the lower part of the valve cap 3, in this moment the valve core 2 has almost turned 90 degree, the path 2-3 in the valve core 2 will get though to the path 30 in the valve body 1 as well as the inlet port 32 and the outlet port 33, at that time the valve is in opened position and due to the spacer 2-1 and the locating pin in the lower part of the valve cap 3 have been touched each other to hold the position, thus the torsion transmission pin 27 with the valve stem 7 in counter-clockwise direction resulting in the torque limited sliding block 23 in the valve core 2 moving down, and the torsion transmission pin 27 being lost touch with the torque limited sliding block 23, hence the telescopic outer sleeve 13 moving up continuously and meanwhile the telescopic inner sleeve 12 moving down, thus the axial distance between them becomes larger (like elongation) at one time the bottom end of the telescopic inner sleeve 12 is clamped through bearing “c” on the valve core 2, and the top end of the telescopic outer sleeve 13 supports upwardly the lower part of the rotational transmission sleeve 10 to hold the valve core 2 tightly pressed and to set up the specific pressure for seal engagement as shown in FIG. 6 and FIG. 7, in the same manner, turning the valve stem in the clockwise direction to close the valve.

### Example 2

As shown in FIG. 8 wherein a sketch for a floating conical plug valve with spring clamp and steel ball, the valve is in closed position, a steel ball is fitted between the center of valve core 2 and spring 19 through spring clamp 19, in order to reduce the friction between spring 19 and valve core 2, the others are the same of that in the example 1.

### Example 3

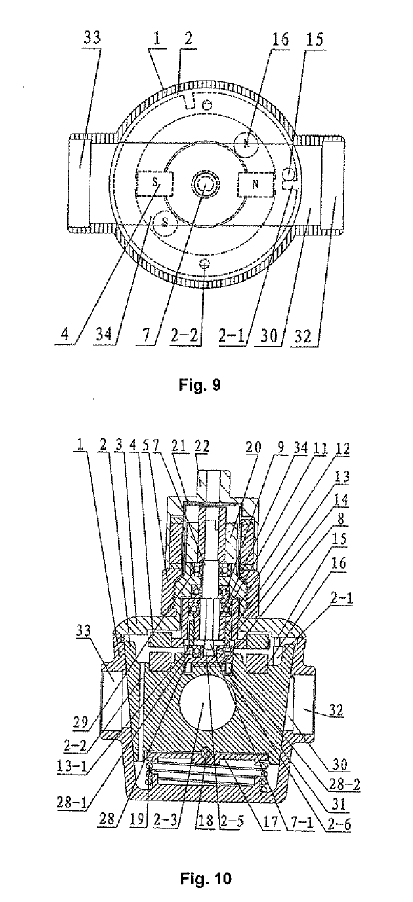

As shown in FIG. 9 wherein a sketched transverse cross-sectional view of a four-way floating conical plug valve for implementation of the example 3, it is dissimilar compared to that in the example 1, there are the first path 2-7 and the second path 2-8 in the valve core 2, and in the valve body there are four ports with the identical angle “D”, “E”, “F”, “G”, the others are the same of that in the example 1, the port “D” and “E” are connected to the first path 2-7, and the port “F” and “G” are connected to the second path 2-8, when the valve core 2 has turned 90°, then the port “D” and “F” are connected to the first path 2-7, and the port “E” and “G” are connected to the second path 2-8.

### Example 4

As shown in FIG. 10 wherein a sketch showing an initiative magnet and a passive magnet used for substitution of the torsion limitation mechanism for implementation of the example 4, the valve is in opened position, there are two passive magnets 16, symmetrically arranged with polarities reverse each other, fitted on the valve core 2 and there are two initiative magnets 4, symmetrically arranged with polarities reverse each other, fitted on the rotational transmission sleeve 34. The initiative and passive magnets substitute the torsion limitation mechanism stated in the example 1, and the others are the same of that in the example 1. When the valve core 2 has lost touch with conical valve chamber 31 completely, the initiative 4 and the passive magnet 16 exactly have been attracted each other due to the reverse polarities and the torque has been also transferred resulting in a 90 degree turning of valve core 2.

### Example 5

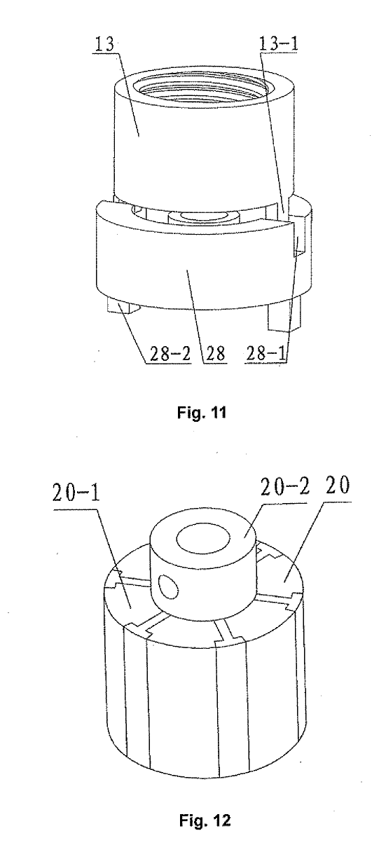

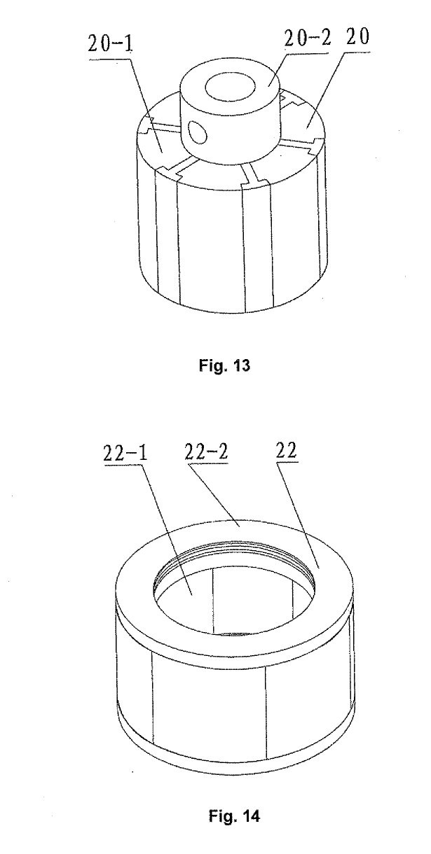

As shown in FIG. 11 wherein a sketch showing the assembly of the rotational transmission sleeve and the initiative magnet for implementation of the example 4, the valve is in closed position, based on implementation of the example 4, the passive sleeve 20, through bearing “d” is fitted on the valve stem 7 located upward the locknut 5. The initiative sleeve 22 is fitted outside of the passive sleeve 20 through the shielding sleeve 21, The telescopic pad 28 is fitted between the lower end of telescopic outer sleeve 13 and the center of the valve core 2, there is a spring gasket 8 underneath the telescopic pad 28. An anti-rotation pin riffle 28-1 is fitted on the lower end of the said telescopic pad 28 and the socket 2-6 for the anti-rotation pin is fitted on the valve core 2, An anti-rotation pin 13-1 is fitted on the lower end of the said telescopic outer sleeve 13 and the anti-rotation slot 28-2 is fitted on the telescopic pad 28, for the purpose to protect the relative rotation between the telescopic 28 and the valve core 2 as well as the telescopic outer sleeve 13 and telescopic pad 28 as shown in FIG. 12, the passive sleeve 20 consists of four to twenty magnet strips 20-1 and the magnet strips rack 20-2, as shown in FIG. 13. A radically magnetized magnet strip 20-1, with the two adjacent strips 20-1 of reverse polarity, thus the quantity of strips must be of the even number. The said initiative sleeve 22 consists of the magnet strip 22-1 and seal ring of initiative sleeve 22-2 as shown in FIG. 14, and the magnet strip 22-1 which quantity is equal to that in passive sleeve 20, but with the reverse polarities, is fitted on the seal ring of initiative sleeve 22-2.

The said shielding sleeve 21 which is made of non-magnetized material such as stainless steel, copper and plastic, is anchored in the valve cap 3 by the locknut 5, the initiative sleeve 22, the passive sleeve 20 and the shielding sleeve 21 are mounted coaxially and the strips in initiative and passive sleeves are of the same length. A sleeve 22-3 is fitted outside of the initiative sleeve 22, according to the principle of reverse polarities attracted each other, when the initiative sleeve 22 turns bringing the turning of passive sleeve 22 together, the dynamic seal of the valve stem 7 is changed to the static seal, if the shielding sleeve 21 would be welded with the valve cap then a leakage free valve could be achieved.

The passive sleeve 20 can also be made by multiple magnet ring, in this regard the initiative sleeve 22 should be made by the some kind of ring, too.

1. A floating conical plug valve comprises the valve body (1) with one inlet port (32) and one outlet port (33) on both sides thereof, and a path (30) connected both ports for medium passing by as well as the conical valve chamber (31) which is intersected to the said path (30) perpendicularly, a conical valve core (2) which can be turned, inserted in conical valve chamber (31) used for cutting off the said path (30) in case of valve closed. The plug valve also comprises a rotational transmission sleeve (10) and a valve stem (7) actuating the valve core (2), the rotational transmission sleeve (10) is outside of the valve stem (7), The floating up spring (19) is clamped between the lower part of valve core (2) and the bottom of valve body (1), The valve cap (3) with locating pin (15) is fitted on the upper end of the valve body (1) which is characterized in that the valve core (2) is a floating conical valve core (2) which can be moved up and down within the conical valve chamber (31). At least one piece of torsion transmission pin (27) with a lower conical section is fitted on the lower end of rotational transmission sleeve (10), and the equivalent quantity of torque limited sliding block (23) with a upper conical section is fitted on the upper end of the valve core (2) and the sliding spring (26) is clamped between valve core (2) and the torque limited sliding block (23). On the lower part of the sliding block is a clamp (24), and the clamp (24) is anchored on valve core (2) by a bolt (25), a locknut (5) for sealing the valve stem (7) by pressing tightly on the seal ring (6) is fitted on the upper end of the valve cap (3), A spring gasket (8) is fitted through bearing “a” (9) between the valve cap (3) and the rotational transmission sleeve (10). A telescopic inner sleeve (12) which can not only be turned simultaneously with rotational transmission sleeve (10) and the valve stem (7) but can also be telescopic upward and downward against the valve stem (7) is fitted between the rotational transmission sleeve (10) and the valve stem (7) though the bearing “b”(11). Outside of the telescopic inner sleeve (12) there is the telescopic outer sleeve (13).

2. The floating conical plug valve according to the claim 1 wherein the said floating conical plug valve is characterized in that the conical half closed angle in the said valve core (2) is in the range of 2 to 30 degree, the path (2-3) is transversely fitted on the valve core (2) and the hole (2-2) for balance has longitudinally been perforated from up to bottom of the valve core (2), the aligned hole (2-5) in the center, two spacers (2-1) with the closed angle larger that 90 degree is on the top, the locating pin (15) underneath the valve cap (3) is fitted between two spacers (2-1) of the valve core (2) and the socket (2-4) on the valve core (2) matches up the anti-rotation pin (13-1).

3. The floating conical plug valve according to the claim 1 wherein the said floating conical plug valve is characterized in that the aligned pin (7-1) is fitted on the lower part of the said valve stem (7).

4. The floating conical plug valve according to the claim 1 wherein the said floating conical plug valve is characterized in that the anti-rotation pin (13-1) is fitted on the lower end of the said telescopic outer sleeve (13), avoiding the relative rotation between telescopic outer sleeve (13) and the valve core (2).

5. The floating conical plug valve according to the claim 1 wherein the said floating conical plug valve is characterized in that the said telescopic mechanism consisting of the telescopic inner sleeve (12) and the telescopic outer sleeve (13) is matched up by means of screw thread with the single or multiple threads which pitch of 0.5 to 10 mm.

6. The floating conical plug valve according to the claim 1 wherein the said floating conical plug valve is characterized in that the steel ball is fitted through the spring clamp (17) between the center in the bottom of valve core (2) and the spring (19).

7. The floating conical plug valve according to the claim 1 wherein the said floating conical plug valve is characterized in that there are the first path (2-7) and the second path (2-8) in the valve core (2), and in the said valve body (1) there are four ports with the identical angle “D”, “E”, “F”, “G”, the port “D” and “E” are connected to the first path (2-7), and the port “F” and “G” are connected to the second path (2-8).

8. The floating conical plug valve according to the claim 1 wherein the said floating conical plug valve is characterized in that there are two passive magnets (16), symmetrically arranged with polarities reverse each other, fitted on valve core (2) and there are two initiative magnets (4), symmetrically arranged with polarities reverse each other, fitted on rotational transmission sleeve (34).

9. The floating conical plug valve according to the claim 1 wherein the said floating conical plug valve is characterized in that the passive sleeve (20) is fitted on the valve stem (7) over the upper end of locknut (5). The initiative sleeve (22) is fitted outside of the passive sleeve (20) through the shielding sleeve (21), The telescopic pad (28) is fitted between the lower end of telescopic outer sleeve (13) and the center of the valve core (2), there is a spring gasket (8) underneath the telescopic pad (28). An anti-rotation pin riffle (28-1) is fitted on the lower end of the said telescopic pad (28) and the socket (2-6) for the anti-rotation pin is fitted on the valve core (2), An anti-rotation pin (13-1) is fitted on the lower end of the said telescopic outer sleeve (13) and the anti-rotation slot (28-2) is fitted on the telescopic pad (28).

10. The floating conical plug valve according to the claim 1 wherein the said floating conical plug valve is characterized in that the said passive sleeve (20) consists of the magnet strip (20-1) and the magnet strip rack (20-2), On the magnet strip rack (20-2) there are four to twenty radically magnetized magnet strips (20-1) and two adjacent strips (20-1) with reverse polarities.

11. The floating conical plug valve according to the claim 1 wherein the said floating conical plug valve is characterized in that The said initiative sleeve (22) consists of the magnet strip (22-1) and of initiative sleeve seal ring (22-2), and the magnet strip (22-1) which quantity is equal to that in passive sleeve (20), but with the reverse polarity, is fitted on the seal ring of initiative sleeve (22-2).
